(19) United States
(12) Patent Application Publication
(10) Pub. No.: US 2005/0031408 A1
(43) Pub. Date: Feb. 10, 2005

(54) Locking an implement

(76) Inventor: John Richard Lemm, Taunton (GB)

Correspondence Address: STITES & HARBISON PLLC, 1199 NORTH FAIRFAX STREET, SUITE 900, ALEXANDRIA, VA, 22314, US

(21) Appl. No.: 10/863,526

(22) Filed: Jun. 9, 2004

(30) Foreign Application Priority Data
Jun. 10, 2003 (GB) 0313329.5

(51) Int. Cl. F16B 21/16

(52) U.S. Cl. 403/324

(57) ABSTRACT

In order to lock an implement to a belt, a locking system is provided having a main pin fixed to the belt, the main pin having a first groove therein, and a casing rotatably mounted on the main pin, the outer casing having a locating hole therein. The implement is thus locked to the belt by aligning the locating hole with the first groove; inserting a male pin to which the implement is attached into the locating hole to a position in which a second groove of the male pin is aligned with the first groove in the main pin; and rotating the male pin relative to the main pin such as to rotate the outer casing, until the second groove is not aligned with the first groove, whereby the male pin is held by the main pin in the casing, thereby to lock the implement to the belt.

### BACKGROUND OF THE INVENTION

1. Field of the Invention

The present invention relates to a method of locking an implement to a support such as a belt or wall, and to an implement attachment apparatus.

2. Summary of the Prior Art

It is well known to attach implements such as tools to the belt of the user using a hook, or other connection which permits the tool to be attached to, and disengaged from, the belt if the user wishes. Such arrangements suffer from the disadvantage that the tools are not securely locked to the belt. More complex arrangements, which lock the tool to the belt, are also know, but the known locking arrangements generally require the use of both hands to lock or unlock the tool. They are therefore inconvenient to use.

### SUMMARY OF THE INVENTION

Therefore, according to the first aspect of the present invention there is provided a method of locking an implement to a support using a locking system comprising a main pin fixed to the belt, the main pin having a first groove therein, and a casing rotatably mounted on the main pin, the outer casing having a locating hole therein,
wherein the method comprises;
aligning the locating hole with the first groove;
inserting a male pin to which the implement is attached into the locating hole to a position in which a second groove of the male pin is aligned with the first groove in the main pin; and
rotating the male pin relative to the main pin such as to rotate the outer casing, until the second groove is not aligned with the first groove, whereby the male pin is held by the main pin in the casing, thereby to lock the implement to the support.

With such an arrangement, the user inserts the male pin, with the tool attached, into the locating hole in the casing, and the male pin is then rotated relative to the main pin. Since the male pin is the casing, the casing also rotates. This rotation operation may be carried out by the user, or may occur under gravity due to the weight of the implement. As the male pin rotates relative to the main pin, the groove in the main pin and the groove in the male pin go out of alignment and part of the main pin then fills the groove in the male pin, to prevent the male pin being withdrawn from the locating hole. The tool is thus locked in place.

The support may be a belt which can then be worn around the waist of a user. In this way the tool can hang from the belt when not needed by the user, be released from the belt when needed, and subsequently be returned to the belt.

Alternatively, the support may be a stability plate which may be fixed to a wall or other surface. Again the tool can be hung from the stability plate when not needed, and released for use.

It should be noted that the rotation of the male pin is not rotation about its elongate access, it is relative to the main pin.

It is convenient if the direction of insertion of the male pin is perpendicular to the access of the main pin. This simplifies the shaping of the grooves.

According to a second aspect of the present invention there is provided a method of locking an inplement to a fixed stability plate using a locking system comprising a main pin fixed to the stability plate, the main pin having a first groove therein, and a casing rotatably mounted on the main pin, the outer casing having a locating hole therein,
wherein the method comprises:
aligning the locating hole with the first groove;
inserting a male pin to which the implement is attached into the locating hole to a position in which a second groove of the male pin is aligned with the first groove in the main pin; and
rotating the male pin relative to the main pin such as to rotate the outer casing, until the second groove is not aligned with the first groove, whereby the male pin is held by the main pin in the casing, thereby to lock the implement to the stability plate.

According to a third aspect of the present invention there is provided an implement attachment apparatus comprising;
a fixed stability plate;
a main pin fixed to the stability plate, the main pin having a first groove therein;
a casing rotatably mounted in the main pin, the outer casing having a locating hole therein alignable with the first groove when the main pin and the casing are in a first position; and
a male pin attachable to the implement, the male pin having a second groove therein;
wherein the male pin is insertable into the locating hole to a position in which the second groove is aligned with the first groove when the main pin and the casing are in the first position, and the male pin and the casing are rotatable relative to the main pin when the male pin is in the locating hole to cause the first and second groove to become unaligned.

According to a fourth aspect of the invention there is provided an implement attachment apparatus comprising;
a support;
a main pin fixed to the support, the main pin having a first groove therein;
a casing rotatably mounted in the main pin, the outer casing having a locating hole therein alignable with the first groove when the main pin and the casing are in a first position; and
a male pin attachable to the implement, the male pin having a second groove therein;
wherein the male pin is insertable into the locating hole to a position in which the second groove is aligned with the first groove when the main pin and the casing are in the first position, and the male pin and the casing being rotatable relative to the main pin when the male pin is in the locating hole to cause the first and second groove to become unaligned.

### BRIEF DESCRIPTION OF THE DRAWINGS

Embodiments of the invention will now be described in detail by way of example, with reference to the accompanying drawings, in which;

FIG. 1 shows a side view of a locking device of a first embodiment of the present invention.

FIG. 2 is a section showing male locating pin;

FIG. 3 shows the unassembled main pin and the outer casing;

FIG. 4 shows a cross-section of the male pin inserted through the locating hole;

FIG. 5 shows the side view of a locking device of the second embodiment of the present invention;

FIGS. 6a to 6c show in more detail the main pin of the second embodiment;

FIG. 7 shows the male pin for use in the second embodiment;

FIG. 8 shows the locking device of FIG. 5 mounted via a stability plate on a wall.

### DETAILED DESCRIPTION

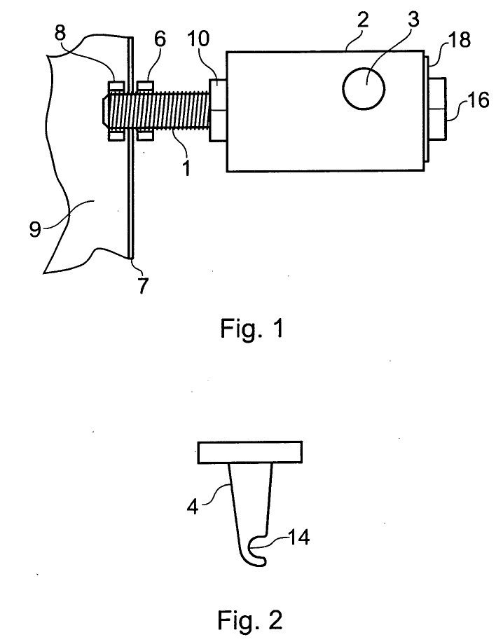

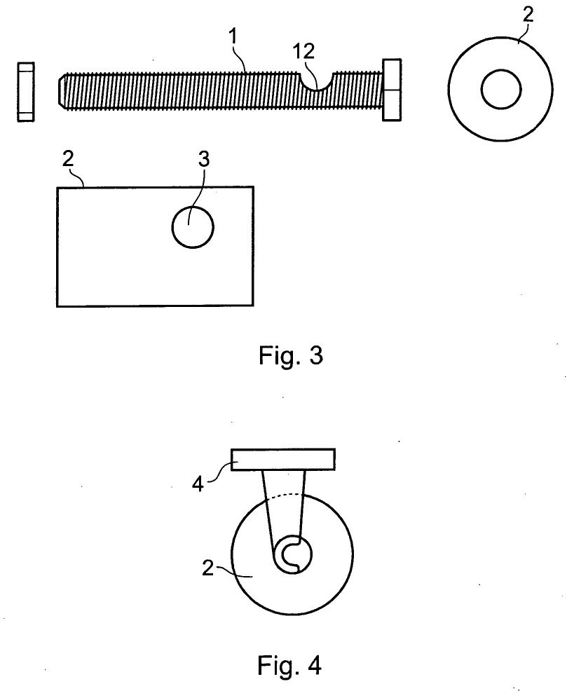

In a first embodiment of the present invention shown in FIGS. 1 to 4 a main pin 1 is attached to a stability plate 7 and locked thereto by locking nuts 6, 8. The stability plate 7 fixes the main pin 1 to a belt (schematically illustrated at 9). The belt 9 may, for example, be worn around the waist of a user.

The locking device has a main pin 1 having a groove 12, which is fitted within an outer casing 2. The outer casing 2 has a locating hole 3, and can be rotated about the main pin 1, and the outer-casing 2 is held between a bolt-head 16 of the fixed main pin 1, via a washer 18 and a locking nut 10. The locking nut 10 can be used to alter the friction experienced by the outer-casing 2, so as to adjust the force required to rotate the outer-casing 2. The main pin 1 is locked to a stabilising plate 7 by the locking nuts 6 and 8, and is in a fixed position relative to a belt.

By rotation of the outer casing 2, the groove 12 of the main pin 1 aligns with the locating hole 3 of the outer casing 2 at a predefined point. In that position it is possible to insert male pin 4 through the locating hole 3 of the outer casing, so that it is received in the groove 12 of main pin 1. The male pin 4 also has a groove 14, so that when the groove 12 of the main pin 1 and the groove 14 of the male pin 4 are aligned, the outer casing can be rotated, and the outer casing 2 and the male pin 4 rotate about the long axis of the main pin 1. The interaction of the body of main pin 1 and the groove 14 of male pin 4 prevent the removal of the male pin 4. To release the male pin 4, the outer casing 2 and the male pin 4 must be rotated to the same point at which the groove 12 of the main pin 1 and the location hole 3 of the outer casing 2 are realigned, and the male pin 4 can be moved axially and thus removed from the groove 12, and the locating hole 3.

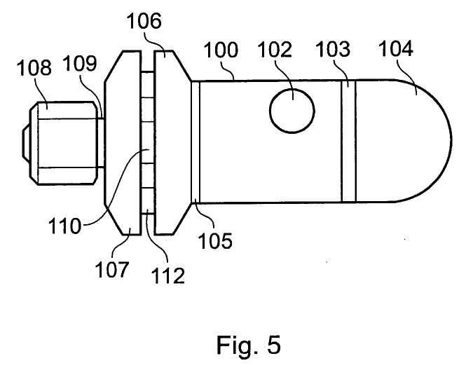

A second embodiment of the present invention will now be described with reference to FIGS. 5-7. In this embodiment, the locking device has an outer casing 100 similar to the casing 2 of the first embodiment, with a locating hole 102 therein. A main pin 110 extends through the casing, and has an end block 104 at one end thereof e.g. by being threaded onto the male pin, and has a locking nut 108 on the other end thereof. A washer 103 is provided between the casing 100 and the end block 104, to permit the casing 100 to rotate easily relative to the end block 104. The main pin 110 also supports to flanges 106, 107 which are joined together by rotating pins 1112. A belt, similar to the belt 9 in FIG. 1, may extend between the flanges, 106, 107, with the locating pins 12 extending through the belt, and thus preventing rotation of the main pin 110 relative to the belt. The belt is not shown in FIG. 5 for the sake of clarity.

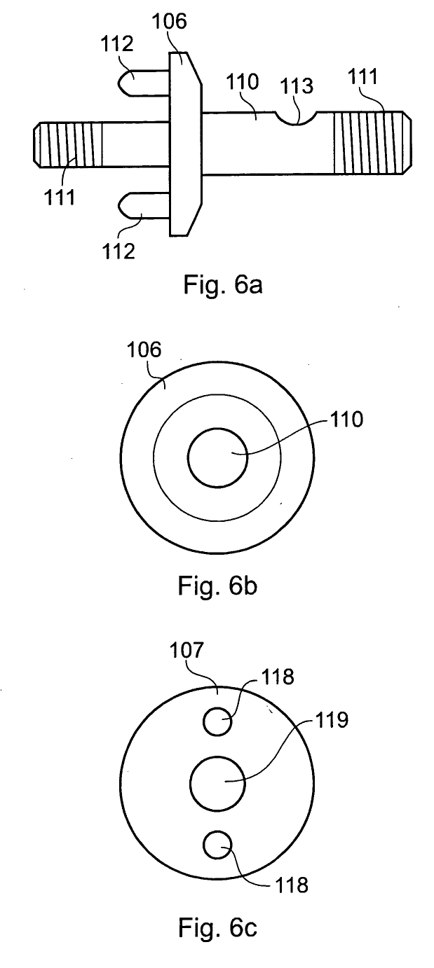

The structure of the main pin is shown in more detail in FIGS. 6a to 6c, and it can be seen that the main pin 110 has threaded regions 111 at its ends, for receiving the end block 104 and the locking nut 108. The flange 106 is fixed to the main pin 110 and the locating pins 112 extend from it. The flange 107 is then mounted on the main pin, with the main pin 110 extending through a hole 119 in the flange 107. The flange 107 has rotating holes 118 therein into which the locating pins 112 are received, to secure the flange 107 to the flange 106 and hence to the male pin 110.

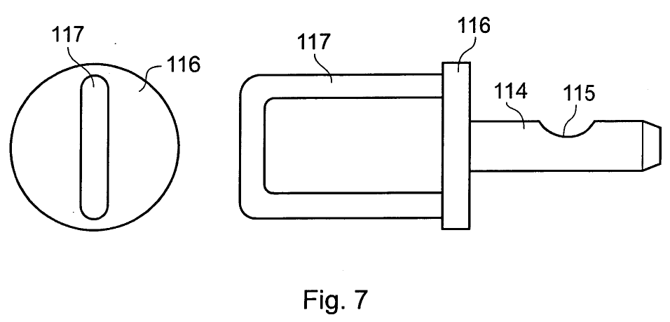

FIGS. 6a also shows that the main pin 113 has a groove 113 in it, corresponding to the groove 12 of the main pin 1 of the first embodiment. FIG. 7 then illustrates the male pin of this embodiment. The male pin comprises a shaft 114 with a groove 115 therein. The shaft 114 has a stop plate 116 mounted on an end thereof, and the stop plate 116 has a bracket 117 extending therefrom, for receiving the tool which is to be secured.

As in the first embodiment, the groove 113 of the main pin 110 aligns with the locating hole 102 of the casing 100 at a predefined point. In that position it is possible to insert the shaft 114 of the male pin through the locating hole 102, so that it is received in the groove 103 of the main pin 100 when the groove 113 of the main pin 110 and the groove 115 of the shaft 114 are all aligned, the outer casing 100 can be rotated, and the outer casing 100 and the male pin rotate about the long axis of the main pin then, the body of the male pin 110 and the groove 115 of the male pin interact to prevent the removal of the male pin from the casing 100.

FIG. 5 also shows that the locking system has a washer 105 on the main pin 110 between the casing 100 and the flange 106, and may also have a washer 109 between the flange 107 and the locking nut 108. The washer 105 makes easy rotation of the casing 100 relative to the flange 106.

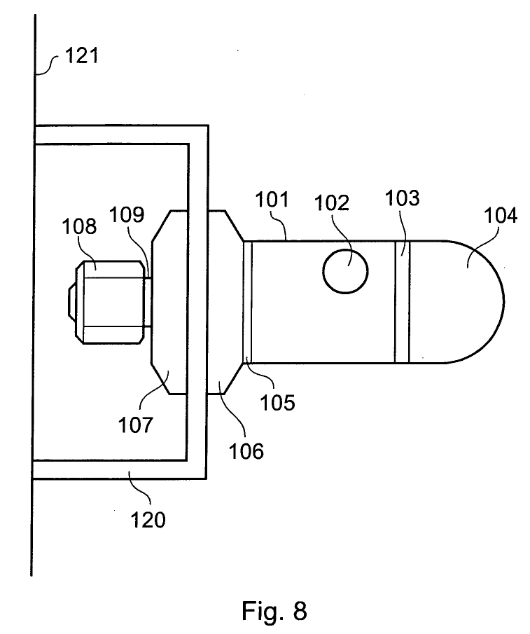

In the above discussion of the second embodiment, it was assumed that the structure shown in FIG. 5 is mounted on a belt. FIG. 8 illustrates an arrangement corresponding to FIG. 5, but in which structure is mounted on a wall. Components of FIG. 8 correspond to those of FIG. 5 are indicated by the same reference numerals. In the arrangement shown in FIG. 8, a stability plate 120 extends between the flanges 106, 107 and is secured to a wall 121. Thus, the structure shown in FIG. 5 is held in a fixed place, to enable a tool to be mounted so that it is suspended from the wall 121 via the locking system. The operation of the locking system shown in FIG. 8 corresponds to that of FIGS. 5 to 7 and will not be described in more detail now.

1. A method of locking an implement to a support using a locking system comprising a main pin fixed to the belt, the main pin having a first groove therein, and a casing rotatably mounted on the main pin, the outer casing having a locating hole therein,
wherein the method comprises;
aligning the locating hole with the first groove;
inserting a male pin to which the implement is attached into the locating hole to a position in which a second groove of the male pin is aligned with the first groove in the main pin; and
rotating the male pin relative to the main pin such as to rotate the outer casing, until the second groove is not aligned with the first groove, whereby the male pin is held by the main pin in the casing, thereby to lock the implement to the support.

2. A method according to claim 1, wherein said support is a belt.

3. A method according to claim 1, wherein said support is a stability plate.

4. A method according to claim 1, wherein said stability plate is mounted on a wall.

5. A method of locking an implement to a fixed stability plate using a locking system comprising a main pin fixed to the stability plate, the main pin having a first groove therein, and a casing rotatably mounted on the main pin, the outer casing having a locating hole therein,
wherein the method comprises;
aligning the locating hole with the first groove;
inserting a male pin to which the implement is attached into the locating hole to a position in which a second groove of the male pin is aligned with the first groove in the main pin; and
rotating the male pin relative to the main pin such as to rotate the outer casing, until the second groove is not aligned with the first groove, whereby the male pin is held by the main pin in the casing, thereby to lock the implement to the stability plate.

6. A method according to claim 1 or claim 5, wherein the direction of insertion of the male pin is perpendicular to the axis of the main pin.

7. An implement attachment apparatus comprising;
a support;
a main pin fixed to the support, the main pin having a first groove therein;
a casing rotatably mounted in the main pin, the outer casing having a locating hole therein alignable with the first groove when the main pin and the casing are in a first position; and
a male pin attachable to the implement, the male pin having a second groove therein;
wherein the male pin is insertable into the locating hole to a position in which the second groove is aligned with the first groove when the main pin and the casing are in the first position, and the male pin and the casing rotatable relative to the main pin when the male pin is in the locating hole to cause the first and second groove to become unaligned.

8. An apparatus according to claim 7, wherein the main pin is attached to the support via a stability plate.

9. An apparatus according to claim 7, wherein said support is a belt.

10. An apparatus according to claim 7, wherein said support is a stability plate.

11. An apparatus according to claim 10, wherein said stability plate is mounted on a wall.

12. An implement attachment apparatus comprising;
a fixed stability plate;
a main pin fixed to the stability plate, the main pin having a first groove therein;
a casing rotatably mounted in the main pin, the outer casing having a locating hole therein alignable with the first groove when the main pin and the casing are in a first position; and
a male pin attachable to the implement, the male pin having a second groove therein;
wherein the male pin is insertable into the locating hole to a position in which the second groove is aligned with the first groove when the main pin and the casing are in the first position, and the male pin and the casing rotatable relative to the main pin when the male pin is in the locating hole to cause the first and second groove to become unaligned.

13. An apparatus according to claim 7 or claim 12, wherein the casing is rotatable through 360° on the main pin.

14. An apparatus according to claim 7 or claim 12, wherein the main pin is a bolt, and the casing is held between a head of the bolt and the nut of the bolt.
